(19) United States
(12) Patent Application Publication
(10) Pub. No.: US 2023/0108633 A1
(43) Pub. Date: Apr. 6, 2023

(54) DETERIORATION DIAGNOSIS DEVICE AND RECORDING MEDIUM

(71) Applicant: NEC Corporation, Minato-ku, Tokyo (JP)

(72) Inventors: Nana JUMONJI, Tokyo (JP); Chisato SUGAWARA, Tokyo (JP)

(73) Assignee: NEC Corporation, Minato-ku, Tokyo (JP)

(21) Appl. No.: 17/908,647

(22) PCT Filed: Feb. 22, 2021
(86) PCT No.: PCT/JP2021/006641

§ 371 Date: Sep. 1, 2022

(30) Foreign Application Priority Data
Mar. 31, 2020 (JP) 2020-062914

(51) Int. Cl. E01C 23/01; G01B 5/28; G08G 1/01

(52) U.S. Cl. CPC E01C 23/01; G01B 5/28; G08G 1/0112; G08G 1/0129

(57) ABSTRACT

A deterioration diagnosis device according to the present invention, includes: a memory; and at least one processor coupled to the memory. The processor performs operations. The operations include: storing a history of a deterioration degree of a portion to be diagnosed in a structure; calculating a deterioration speed of the portion based on the history; selecting the portion satisfying a condition related to the deterioration degree and a condition related to the deterioration speed; and outputting information related to the selected portion.

### TECHNICAL FIELD

The present invention relates to diagnosis of deterioration with respect to a structure such as a road.

### BACKGROUND ART

Structures such as a surface of a road, a sign installed on a road side, and a ceiling and a side wall of a tunnel or the like deteriorate over time.

In this regard, a device for measuring a deterioration of a structure or the like has been proposed (for example, see PTL 1 to PTL 3).

A road surface inspection program described in PTL 1 determines a deteriorating position on a road surface by using a frequency at which an acceleration is measured at a deterioration candidate position.

A road management system described in PTL 2 predicts a road surface property on the basis of a change in road surface property and a transition in traffic volume during a measurement period.

An information processing device described in PTL 3 stores a road structure in an image captured from a vehicle and a position of the vehicle in association with each other.

### CITATION LIST

### Patent Literature

[PTL1] JP 2013-140448 A

[PTL2] JP 2019-185443 A

[PTL3] JP 2016-151967 A

### SUMMARY OF INVENTION

### Technical Problem

A general road surface deterioration diagnosis device diagnoses a deterioration of a road surface or the like for each predetermined portion (e.g., every 100 m) by using an image.

A user of the deterioration diagnosis device can grasp a portion of a road surface that requires repair by using a result of diagnosing the deterioration of the road surface for each portion output from the deterioration diagnosis device.

However, a long road having a surface to be repaired causes a considerably large number of deterioration diagnosis results.

Even if the diagnosis of deterioration is limited to a road managed by each local government, the road managed by each local government has a length of thousands of kilometers (km).

As a result, the deterioration diagnosis device outputs tens of thousands or more of road surface deterioration diagnosis results.

Therefore, it is necessary for a user to select a portion that needs to be preferentially repaired from many deterioration diagnosis results.

As described above, in each of the techniques described in PTL 1 to PTL 3, a value indicating a degree of deterioration is calculated (hereinafter, referred to as a “deterioration level”).

Accordingly, the user can narrow down portions to be diagnosed on the road surface using the calculated deterioration level.

However, in general, results of diagnosing deteriorations of road surfaces to be repaired (deterioration levels) are classified into several groups. For example, when the road surfaces are sorted using crack rates, the road surfaces are classified into three groups (low-level deterioration (deterioration rate: 0% to 20%), medium-level deterioration (deterioration rate: 20% to 40%), and high-level deterioration (deterioration rate: 40% or more)).

Therefore, even if the techniques described in PTL 1 to PTL 3 are used, each group includes about hundreds to thousands of portions. Therefore, for example, when selecting a portion that needs to be preferentially repaired from among portions included in a high-level deterioration group, the user needs to select a portion that needs to be preferentially repaired from among hundreds to thousands of diagnosis results. However, in order to manually select a portion that needs to be preferentially repaired from among hundreds to thousands of diagnosis results, considerable man-hours are required.

As described above, the techniques described in PTL 1 to PTL 3 have a problem that it is difficult to narrow down portions to be subjected to deterioration diagnosis to an appropriate amount.

Therefore, there has been a demand for a technique capable of further narrowing down portions to be subjected to deterioration diagnosis after narrowing down portions to be subjected to deterioration diagnosis using a deterioration diagnosis result such as a deterioration level.

In order to solve the above-described problem, an object of the present invention is to provide a deterioration diagnosis device or the like capable of further narrowing down portions to be subjected to deterioration diagnosis after narrowing down portions to be subjected to deterioration diagnosis using a deterioration diagnosis result.

### Solution to Problem

According to one example aspect of the present invention, a deterioration diagnosis device includes:
a deterioration information storage means configured to store a history of a deterioration degree of a portion to be diagnosed in a structure;
a deterioration speed calculation means configured to calculate a deterioration speed of the portion based on the history;
a portion selection means configured to select the portion satisfying a condition related to the deterioration degree and a condition related to the deterioration speed; and
an output means configured to output information related to the selected portion.

According to another example aspect of the present invention, a deterioration diagnosis system includes:
the above-described deterioration diagnosis device;
an input device configured to transmit the condition related to the deterioration degree and the condition related to the deterioration speed to the deterioration diagnosis device; and
a display device configured to display the portion satisfying the condition related to the deterioration degree and the condition related to the deterioration speed by using the information related to the portion output from the deterioration diagnosis device.

According to another example aspect of the present invention, a deterioration diagnosis method includes:
storing a history of a deterioration degree of a portion to be diagnosed in a structure;
calculating a deterioration speed of the portion based on the history;
selecting the portion satisfying a condition related to the deterioration degree and a condition related to the deterioration speed; and
outputting information related to the selected portion.

According to another example aspect of the present invention, a recording medium records a program for causing a computer to execute the following processing:
storing a history of a deterioration degree of a portion to be diagnosed in a structure;
calculating a deterioration speed of the portion based on the history;
selecting the portion satisfying a condition related to the deterioration degree and a condition related to the deterioration speed; and
outputting information related to the selected portion.

### ADVANTAGEOUS EFFECTS OF INVENTION

According to the present invention, it is possible to obtain an effect in that, after narrowing down portions to be subjected to deterioration diagnosis using a deterioration diagnosis result, portions to be subjected to deterioration diagnosis are further narrowed down.

### BRIEF DESCRIPTION OF DRAWINGS

FIG. 1 is a block diagram illustrating an example of a configuration of a deterioration diagnosis system including a deterioration diagnosis device according to a first example embodiment.

FIG. 2 is a flowchart illustrating an example of an operation of the deterioration diagnosis device.

FIG. 3 is a diagram illustrating an example in which selection conditions are displayed.

FIG. 4 is a diagram illustrating an example in which portions used to describe a specific example are displayed.

FIG. 5 is a diagram illustrating an example of an operation when “high” is selected as a deterioration degree.

FIG. 6 is a diagram illustrating an example of display when portions of which deterioration degrees are high have been selected.

FIG. 7 is a diagram illustrating an example of an operation when “high” is further selected as a deterioration speed in the state of FIG. 5.

FIG. 8 is a diagram illustrating an example of display when portions of which deterioration degrees are high are selected and portion of which deterioration speeds are high are further selected.

FIG. 9 is a diagram illustrating an example of a deterioration curve.

FIG. 10 is a diagram for explaining a selection of the deterioration diagnosis device.

FIG. 11 is a diagram for explaining information related to a deterioration speed output by the deterioration diagnosis device.

FIG. 12 is a block diagram illustrating an example of a hardware configuration of the deterioration diagnosis device.

FIG. 13 is a block diagram illustrating an example of a configuration of a deterioration diagnosis device according to a second example embodiment.

FIG. 14 is a flowchart illustrating an example of an operation of the deterioration diagnosis device according to the second example embodiment.

FIG. 15 is a block diagram illustrating an example of a configuration of a deterioration diagnosis system including the deterioration diagnosis device according to the second example embodiment.

FIG. 16 is a diagram illustrating an outline of ITS.

### EXAMPLE EMBODIMENT

Next, example embodiments of the present invention will be described with reference to the drawings.

Each drawing is for describing an example embodiment of the present invention. However, the present invention is not limited to the illustration of each drawing. In addition, the same components are denoted by the same reference numerals in the drawings, and repeated description thereof may be omitted. In addition, in the drawings used in the following description, portions that are not related to the description of the present invention may not be illustrated.

### Terms

First, terms to be used in the description of example embodiments will be explained.

The term “deterioration degree” is a deterioration diagnosis result (e.g., a degree of deterioration) for a portion that is a diagnosis target in a structure.

In order to express the “deterioration degree”, any form may be used. For example, a numerical value may be used to express the deterioration degree. Alternatively, what is other than a numerical value may be used to express the deterioration degree. For example, a word such as “low”, “medium”, or “high” may be used to express the deterioration degree.

In each example embodiment, a predetermined analysis method is applied to an image including a portion to be diagnosed in a structure to calculate a deterioration degree of each portion. In each example embodiment, a target may be any structure. For example, the structure may be a social infrastructure such as a road (e.g., a road surface, a sign, or a ceiling and a side wall of a tunnel or the like), a railway, a harbor, a dam, or a communication facility. Alternatively, the structure may be a life-related social capital structure such as a school, a hospital, a park, or a social welfare facility.

However, in each example embodiment, the deterioration degree may be calculated using information other than the image. For example, in each example embodiment, the deterioration degree may be calculated using an acceleration detected by an acceleration sensor or the like. In each example embodiment, the deterioration degree may be calculated for the entire structure rather than each portion.

A value of the deterioration degree is within a certain range.

For example, in each example embodiment, a crack rate of a road surface may be used as the deterioration degree. In this case, the value of the deterioration degree is in the range of 0.0 to 1.0 (0% to 100%).

Alternatively, in each example embodiment, a rutting amount may be used as the deterioration degree. In this case, the value of the deterioration degree is generally an integer of 0 or more (the unit is mm). Note that a rational number may be used as the value of the rutting amount.

Alternatively, in each example embodiment, an international roughness index (IRI) may be used as the deterioration degree. In this case, the value of the deterioration degree is a rational number of 0 or more (the unit is mm/m).

Alternatively, in each example embodiment, a maintenance control index (MCI) may be as the deterioration degree. The MCI is a composite deterioration index obtained from a crack rate, a rutting amount, and a flatness.

As described above, the value of the deterioration degree is within a certain range. In each example embodiment, a user may appropriately select a deterioration degree corresponding to the deterioration of the structure to be repaired.

In the following description, a crack rate will be used as an example of the deterioration degree. Therefore, in the following description, the value of the deterioration degree increases as the condition is worse. However, as the value of the deterioration degree, a smaller numerical value may be used as the condition is worse in relation to processing using the deterioration degree.

The term “deterioration speed” is a degree of change in deterioration degree with respect to time.

In each example embodiment, the deterioration speed may be temporally constant or may be changed. A user may select the type of deterioration speed depending on what a diagnosis target is.

For example, a linear approximation such as linear regression may be used to indicate a deterioration speed. Alternatively, a quadratic curve (quadratic regression) may be used to indicate a deterioration speed.

As will be described below, in each example embodiment, a “deterioration degree” and a “deterioration speed” are used as conditions for selecting a portion as a diagnosis target. However, this does not limit each example embodiment. In each example embodiment, either or both of the “deterioration degree” and the “deterioration speed” may not be used as long as two or more selection conditions are used.

In the following description, a case where “high” is selected as a “deterioration speed” is selected in addition to “high” as a “deterioration degree” will be described. However, in each example embodiment, the selection is not limited thereto. For example, in each example embodiment, among portions of which “deterioration degree” is “low” or “medium”, a portion of which “deterioration speed” is “high” may be selected. Such a portion is not required to be repaired at a current time, but is likely to be required to be repaired in the near future.

Furthermore, in each example embodiment, a deterioration degree corresponding to a plurality of deterioration indexes may be used. For example, in each example embodiment, a crack rate and a rutting amount may be used as the deterioration indexes. In this case, in each example embodiment, selections for the respective deterioration indexes, each using a deterioration degree and a deterioration speed, may be combined together. In the following description, a case in which one deterioration index is used will be described for clarity.

### First Example Embodiment

Hereinafter, a first example embodiment will be described with reference to the drawings.

### Description of Configuration

First, a configuration of a deterioration diagnosis device 100 according to the first example embodiment will be described with reference to the drawings.

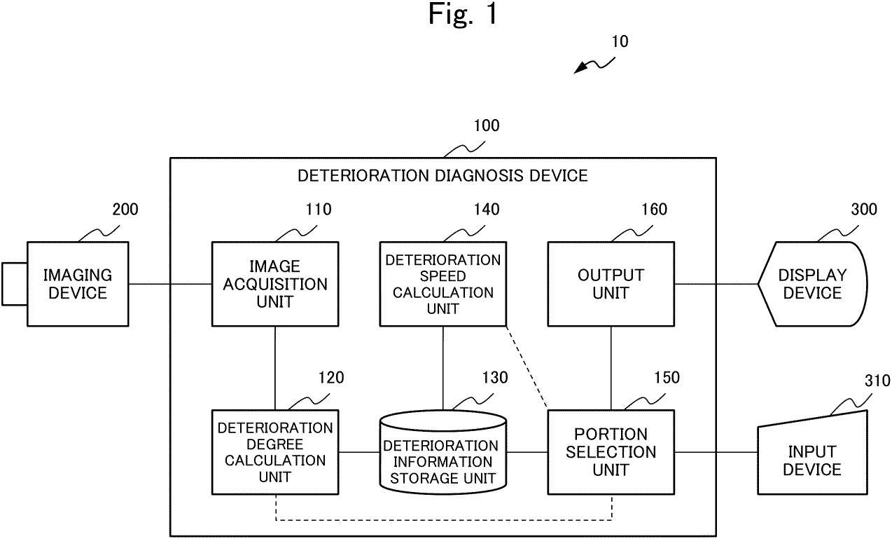

FIG. 1 is a block diagram illustrating an example of a configuration of a deterioration diagnosis system 10 including the deterioration diagnosis device 100 according to the first example embodiment.

The deterioration diagnosis system 10 includes a deterioration diagnosis device 100, an imaging device 200, a display device 300, and an input device 310.

The imaging device 200 captures an image including a portion to be diagnosed in a structure (e.g., a road surface, a sign, a ceiling, and/or a side wall).

The deterioration diagnosis system 10 can use any device as the imaging device 200 as long as the device can capture an image including a portion to be diagnosed. For example, the deterioration diagnosis system 10 may use a drive recorder installed for the purpose of recording a situation when an automobile accident occurs as the imaging device 200. Alternatively, the deterioration diagnosis system 10 may use a camera (e.g., an omnidirectional camera) that captures a scene as the imaging device 200.

Alternatively, the imaging device 200 may be an imaging device mounted on a vehicle used for an intelligent transport system (ITS) or the like. The intelligent transport system (ITS) is a transport system using information technology (IT).

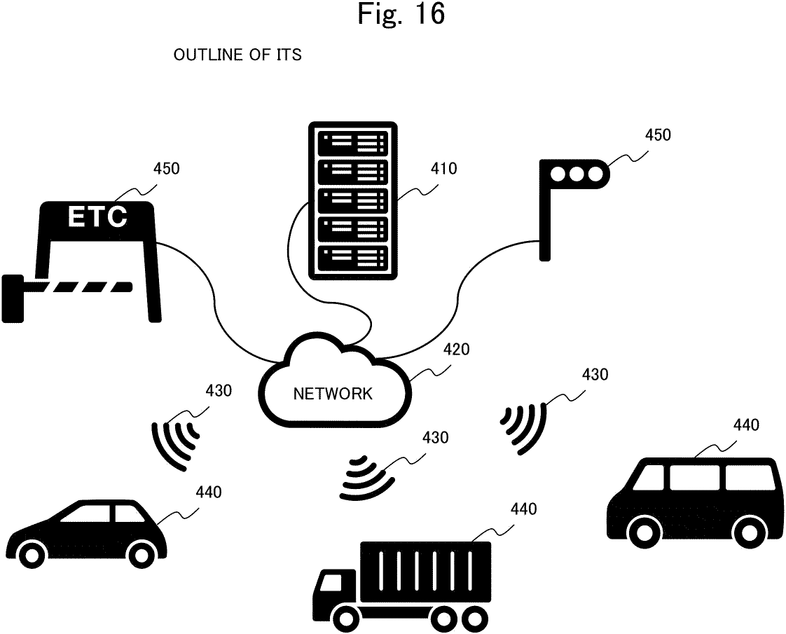

FIG. 16 is a diagram illustrating an outline of ITS.

An information processing device 410 collects information from a vehicle 440 via a network 420 and/or a communication path 430. Then, the information processing device 410 controls facilities 450 installed on a road or the like on the basis of the collected information to execute predetermined processing (e.g., assistance in safe driving or management of roads). The facilities 450 may be any types of facilities. In FIG. 16, a traffic light and an electronic toll collection system (ETC in FIG. 16) are shown as examples of the facilities 450.

Alternatively, the deterioration diagnosis system 10 may use a camera used for automatic driving as the imaging device 200. In this manner, the deterioration diagnosis system 10 may be used in an automatic driving system.

The description will be made referring back to FIG. 1.

The imaging device 200 transmits the captured image to the deterioration diagnosis device 100 together with an imaging time.

The imaging device 200 may be included in the deterioration diagnosis device 100.

The input device 310 receives, from a user or the like, an input of a condition for selecting a portion as a deterioration diagnosis target (hereinafter, referred to as “selection condition”) to the deterioration diagnosis device 100. Then, the input device 310 transmits the received selection condition to the deterioration diagnosis device 100.

As will be described below, the deterioration diagnosis device 100 uses at least two conditions in selecting a portion as a deterioration diagnosis target. Therefore, the selection condition includes a plurality of conditions.

The input device 310 may transmit two or more conditions in a lump to the deterioration diagnosis device 100, or may individually transmit the conditions to the deterioration diagnosis device 100.

In a case where the selection condition is changed, the input device 310 may transmit the changed selection condition to the deterioration diagnosis device 100, or may transmit the changed content in the selection condition to the deterioration diagnosis device 100.

The input device 310 may display information required for receiving an input. For example, the input device 310 may include a display device such as a liquid crystal display. Alternatively, the input device 310 may receive an input in cooperation with the display device 300.

The input device 310 may be included in the deterioration diagnosis device 100. For example, the input device 310 may be a keyboard, a mouse, or a touch pad.

The display device 300 receives an output (at least information related to the selected portion) of the deterioration diagnosis device 100, which will be described later, and displays a portion by using the received output of the deterioration diagnosis device 100.

The deterioration diagnosis system 10 can use any device as the display device 300 as long as the device can display an output of the deterioration diagnosis device 100. For example, the deterioration diagnosis system 10 may use a display device included in a system that manages repairs of roads as the display device 300. Alternatively, the deterioration diagnosis system 10 may use a display device of a terminal device carried by a user (e.g., a liquid crystal display of a terminal) as the display device 300.

The display device 300 may be included in the deterioration diagnosis device 100. For example, the display device 300 may be a liquid crystal display, an organic electroluminescence display, or electronic paper.

As described above, the display device 300 may display information that assists an input through the input device 310.

Alternatively, the display device 300 and the input device 310 may be included in one device rather than different devices. For example, the display device 300 and the input device 310 may be achieved using a computer device including a liquid crystal display, a keyboard, and a mouse. Alternatively, the display device 300 and the input device 310 may be achieved using a touch panel including a touch pad and a liquid crystal display.

The deterioration diagnosis device 100 acquires an image from the imaging device 200. Then, the deterioration diagnosis device 100 calculates a deterioration degree of a portion as a diagnosis target included in the image. Further, the deterioration diagnosis device 100 stores the calculated deterioration degree as a history on the basis of an imaging time. Then, the deterioration diagnosis device 100 calculates a deterioration speed on the basis of the history. Then, the deterioration diagnosis device 100 selects a portion in which the deterioration degree and the deterioration speed satisfy the selection conditions. Then, the deterioration diagnosis device 100 transmits information related to the selected portion (e.g., information related to a position of the selected portion) to the display device 300.

Next, a configuration of the deterioration diagnosis device 100 will be described.

The deterioration diagnosis device 100 includes an image acquisition unit 110, a deterioration degree calculation unit 120, a deterioration information storage unit 130, a deterioration speed calculation unit 140, a portion selection unit 150, and an output unit 160.

The image acquisition unit 110 acquires an image including a portion to be diagnosed in a structure (e.g., a surface of a road, or a side wall and a ceiling of a tunnel) and a time at which the image is captured. The image acquisition unit 110 may acquire information related to a position of a portion to be diagnosed (hereinafter, referred to as “position information”). The position information includes, for example, a latitude and a longitude of the portion. The position information may include a direction of the portion.

The deterioration degree calculation unit 120 calculates a deterioration degree of a portion that is a diagnosis target using a predetermined method.

The deterioration degree calculation unit 120 may use any method when calculating a deterioration degree. For example, the deterioration degree calculation unit 120 calculates an area of a road surface and an area of a crack in the image by using predetermined image recognition. Then, the deterioration degree calculation unit 120 calculates a crack rate of the road surface as a deterioration degree on the basis of the calculated area of the road surface and the calculated area of the crack.

The deterioration degree calculation unit 120 may calculate a deterioration degree by using predetermined machine learning or artificial intelligence. The deterioration degree calculation unit 120 may determine the type of deterioration (e.g., a crack or a rut) included in the image by using predetermined image recognition, machine learning, or artificial intelligence, and calculate a deterioration degree in the determined type of deterioration. The image may include information on imaging time and imaging position as the information.

The image may include a plurality of portions as diagnosis targets. In that case, the deterioration degree calculation unit 120 may calculate deterioration degrees for all of the plurality of portions. Alternatively, the deterioration degree calculation unit 120 may calculate a deterioration degree for a portion selected in accordance with a predetermined selection rule.

The deterioration degree calculation unit 120 stores, in the deterioration information storage unit 130, a history of deterioration degree corresponding to the portion by using the calculated deterioration degree and the calculated imaging time.

When there are a plurality of portions to be diagnosed, the deterioration degree calculation unit 120 stores a history corresponding to each portion in the deterioration information storage unit 130. For example, the deterioration degree calculation unit 120 may store a history of deterioration degree at a position of each portion to be diagnosed, by using position information of the portion.

The deterioration diagnosis device 100 may acquire the position information in any method. For example, the image acquisition unit 110 may acquire the position information from the imaging device 200. Alternatively, a position calculation device, which is not illustrated, may calculate the position information by using the acquired image and map information in which the image is associated with a position.

The deterioration information storage unit 130 stores a history of deterioration degree.

The deterioration speed calculation unit 140 calculates a deterioration speed by using the stored history.

When there are a plurality of portions to be diagnosed, the deterioration speed calculation unit 140 calculates a deterioration speed for each of the plurality of portions.

The deterioration speed calculation unit 140 stores the calculated deterioration speed in the deterioration information storage unit 130 in association with a portion to be diagnosed. Alternatively, the deterioration speed calculation unit 140 may store the deterioration speed in a storage device that is not illustrated. Alternatively, the deterioration speed calculation unit 140 may output the calculated deterioration speed to the portion selection unit 150.

The deterioration speed calculation unit 140 may calculate a deterioration speed in any method. For example, the deterioration speed calculation unit 140 may calculate a deterioration speed by applying predetermined regression analysis (e.g., linear regression or quadratic curve regression) to the history.

Alternatively, the deterioration speed calculation unit 140 may calculate a deterioration speed by using predetermined machine learning or artificial intelligence.

The portion selection unit 150 receives a selection condition from the input device 310. In the following description, it is assumed that the selection conditions include at least a condition related to deterioration degree (hereinafter, referred to as “deterioration degree condition”) and a condition related to deterioration speed (hereinafter, referred to as “deterioration speed condition”). However, as described above, the selection conditions may include another condition. The portion selection unit 150 may receive selection conditions including three or more conditions.

The portion selection unit 150 may receive selection conditions including both a deterioration degree condition and a deterioration speed condition. Alternatively, the portion selection unit 150 may separately receive a selection condition including a deterioration degree condition and a selection condition including a deterioration speed condition.

Then, the portion selection unit 150 selects a portion in which the calculated deterioration degree and the calculated deterioration speed satisfy the selection conditions (deterioration degree condition and deterioration speed condition) from among portions that are diagnosis targets.

The portion selection unit 150 may select a portion by simultaneously using both the deterioration degree condition and the deterioration speed condition. Alternatively, the portion selection unit 150 may select portions satisfying one selection condition, and select a portion satisfying another selection condition from among the selected portions. For example, the portion selection unit 150 may first select portions by using the deterioration degree condition, and then further select a portion by using the deterioration speed condition from among the selected portions. In this case, the portion selection unit 150 may sequentially transmit selection results to the output unit 160.

Similarly, when the portion selection unit 150 receives selection conditions including three or more conditions, the portion selection unit 150 may select a portion using all the conditions. Alternatively, the portion selection unit 150 may select a portion by sequentially applying a plurality of conditions in accordance with a predetermined rule. In this case, the portion selection unit 150 may sequentially transmit selection results to the output unit 160.

The portion selection unit 150 selects a portion by using the deterioration degree and the deterioration speed stored in the deterioration information storage unit 130. However, the portion selection unit 150 may acquire at least one or both of the deterioration degree and the deterioration speed from the deterioration degree calculation unit 120 and/or the deterioration speed calculation unit 140.

Then, the portion selection unit 150 outputs the selected portion to the output unit 160.

The output unit 160 outputs information related to the selected portion. Alternatively, the output unit 160 may output information related to unselected portions instead of the information related to the selected portion. In a case where a portion is further selected from among previously selected portions, the output unit 160 may output information related to unselected portions.

The output unit 160 may match specifications of information to be output in advance with a device to which the information is to be output.

In the following description, as an example, the output unit 160 outputs “information related to a selected portion”.

Furthermore, the information output by the output unit 160 may include any content. A user of the deterioration diagnosis device 100 may select information to be output depending on where the information is to be output.

An example of information output by the output unit 160 will be described.

For example, in a case where the display device 300 displays a selected portion by using a position of the portion (such as a case where the display device 300 displays an image on a map at a position corresponding to the portion), the output unit 160 may output position information (e.g., a latitude and a longitude) of the selected portion.

Alternatively, for example, in a case where the display device 300 displays a deterioration degree of each portion at a position of each portion on the map, the output unit 160 may output position information and a deterioration degree of the selected portion.

In order to output the information related to the selected portion, the output unit 160 may appropriately acquire the information from a component in which the information is stored or a component in which the information can be output. For example, in a case where position information is output, the output unit 160 may acquire the position information from the image acquisition unit 110 or the deterioration information storage unit 130.

### Description of Operation

Next, an operation of the deterioration diagnosis device 100 according to the first example embodiment will be described with reference to the drawings.

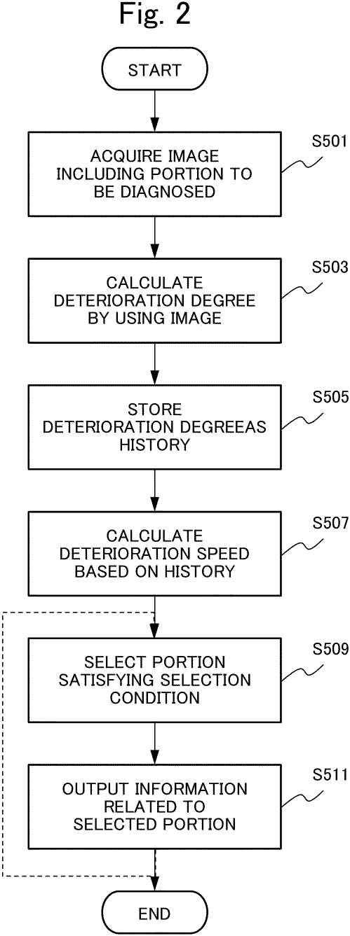

FIG. 2 is a flowchart illustrating an example of the operation of the deterioration diagnosis device 100.

The image acquisition unit 110 acquires an image including a portion to be diagnosed (step S501).

The deterioration degree calculation unit 120 calculates a deterioration degree by using the image (step S503).

The deterioration information storage unit 130 stores the deterioration degree as a history (step S505).

The deterioration speed calculation unit 140 calculates a deterioration speed on the basis of the history (step S507).

The portion selection unit 150 receives selection conditions (a condition related to the deterioration degree and a condition related to the deterioration speed). Then, the portion selection unit 150 selects a portion satisfying the selection conditions (step S509).

The output unit 160 outputs information related to the selected portion (step S511).

Then, the deterioration diagnosis device 100 ends the operation.

The deterioration diagnosis device 100 may operate to repeat the steps S509 and S511.

For example, the deterioration diagnosis device 100 waits until receiving a selection condition from the input device 310 after operating up to the step S507. When receiving a selection condition from the input device 310, the deterioration diagnosis device 100 operates from the step S509 to the step S511. Then, the deterioration diagnosis device 100 may wait again until receiving a selection condition from the input device 310.

### Specific Example

Next, a specific example of a selection operation of the deterioration diagnosis device 100 will be described with reference to the drawings.

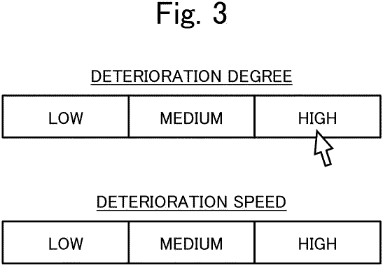

FIG. 3 is a diagram illustrating an example in which selection conditions are displayed. In the example of FIG. 3, a portion to be diagnosed is selected using a deterioration degree and a deterioration speed as selection conditions.

The input of the selection condition using the display illustrated in FIG. 3 will be described.

In the following description, it is assumed that the display device 300 and the input device 310 are achieved using a computer device including a liquid crystal display, a keyboard, and a mouse.

The display device 300 displays the selection condition illustrated in FIG. 3.

The input device 310 moves a cursor (or a mouse pointer) according to a user’s mouse operation or the like. Then, when detecting a button having been pressed (clicked) at a position where the cursor is superimposed on a selection condition, the input device 310 transmits the selection condition (e.g., high deterioration degree) at that position to the deterioration diagnosis device 100. In the following description, such operations may be collectively referred to as the wording “a user selects a selection condition”. In FIG. 3, an oblique arrow is shown as the cursor.

The deterioration diagnosis device 100 selects portions satisfying the received selection condition (e.g., high deterioration degree). Then, the deterioration diagnosis device 100 transmits information related to the selected portions to the display device 300.

The display device 300 changes its display by using the information received from the deterioration diagnosis device 100.

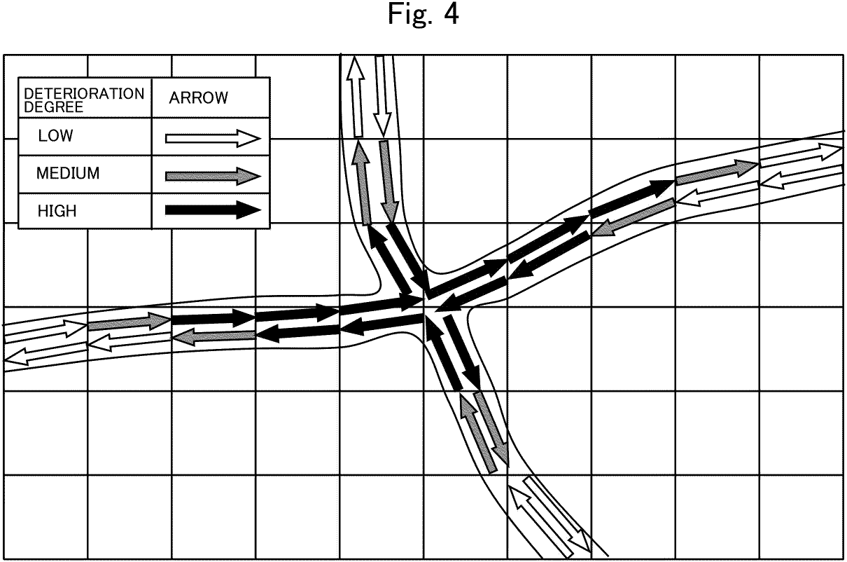

FIG. 4 is a diagram illustrating an example in which portions used to describe the following specific example are displayed. In the example of FIG. 4, a road is used as a diagnosis target.

In FIG. 4, each arrow indicates a result of diagnosis in each portion. A black-color arrow indicates a portion of which deterioration degree is high. A gray-color arrow indicates a portion of which deterioration degree is medium. A white-color arrow indicates a portion of which deterioration degree is low.

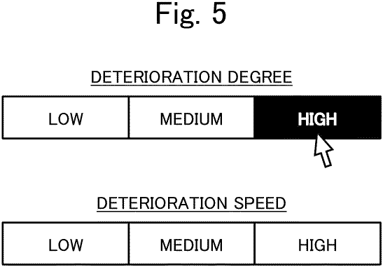

FIG. 5 is a diagram illustrating an example of an operation when “high” is selected as a deterioration degree. As illustrated in FIG. 5, when a user selects “high” as a deterioration degree on the input device 310, the input device 310 transmits “high deterioration degree” as a selection condition to the deterioration diagnosis device 100. In FIG. 5, the selected selection condition (high deterioration degree) is displayed in an inverted manner.

When receiving “high deterioration degree” as the selection condition, the deterioration diagnosis device 100 selects portions of which deterioration degrees are “high” and outputs information related to the selected portions.

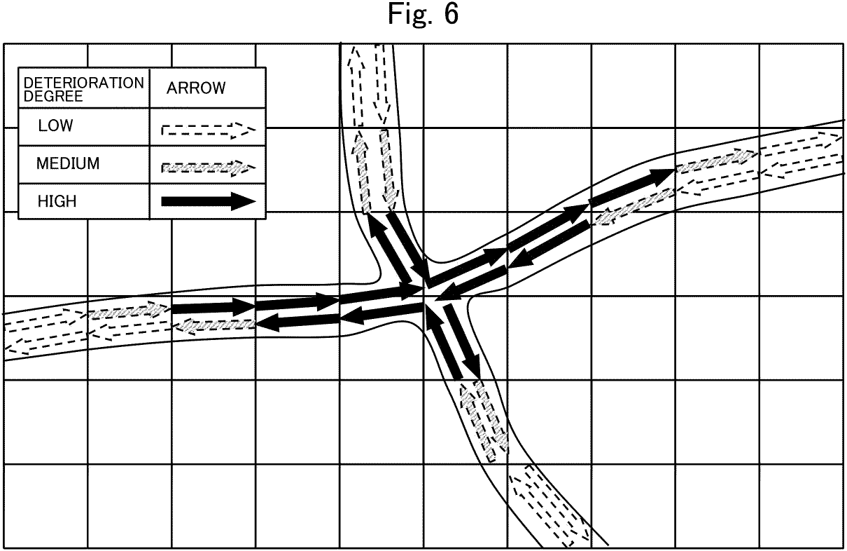

FIG. 6 is a diagram illustrating an example of display when portions of which deterioration degrees are high have been selected. In the example of FIG. 6 in which portions of which deterioration degrees are high have been selected, the other portions (portions of which deterioration degrees are medium and low) are displayed in different manners. A portion of which deterioration degree is low is indicated by an arrow having an outline in a broken line. A portion of which deterioration degree is medium is indicated by an arrow having an outline in a broken line with grey oblique lines inside the arrow.

The display of the display device 300 is not limited to what has been described above. For example, the display device 300 may leave portions of which deterioration degrees are high while not displaying the other portions. Alternatively, the display device 300 may display portions of which deterioration degrees are high in a different manner. For example, the display device 300 may blink portions of which deterioration degrees are high. Alternatively, the display device 300 may enlarge figures indicating portions of which deterioration degrees are high.

The deterioration diagnosis device 100 can further narrow down portions to be diagnosed.

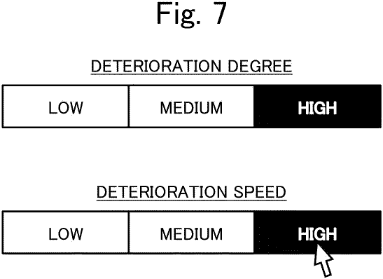

FIG. 7 is a diagram illustrating an example of an operation when “high” is further selected as a deterioration speed in the state of FIG. 5. As illustrated in FIG. 7, when a user selects “high” as a deterioration speed, the input device 310 transmits “high deterioration speed” as a selection condition. The input device 310 may transmit the already selected “high deterioration degree” together with “high deterioration speed” as selection conditions. In FIG. 7, the selected selection conditions (high deterioration degree and high deterioration speed) are displayed in an inverted manner.

The deterioration diagnosis device 100 receives “high deterioration speed” as a selection condition. Then, the deterioration diagnosis device 100 selects portions of which deterioration speeds are “high” from among the selected portions of which deterioration degrees are “high”, and outputs information related to the selected portions.

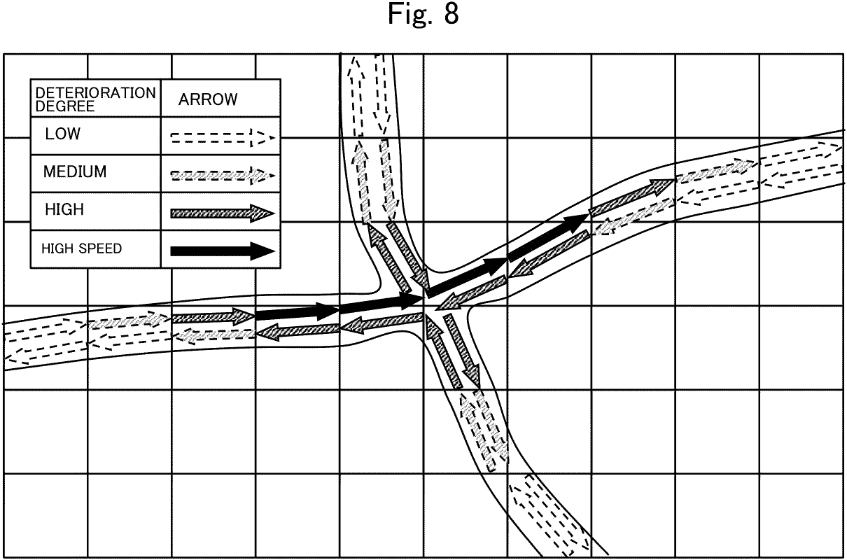

FIG. 8 is a diagram illustrating an example of display when portions of which deterioration degrees are high are selected and portion of which deterioration speeds are high are further selected. In the example of FIG. 8 in which portions of which deterioration speeds are high have been selected, portions of which deterioration speeds are not high (portions of which deterioration speeds are low and medium) from among the portions of which deterioration degrees are high are displayed in a different manner from those displayed in FIG. 6. Specifically, a portion of which deterioration speed is not high is indicated by an arrow with oblique lines inside.

As described above, the display device 300 displays the portions satisfying the selection conditions (deterioration degree condition and deterioration speed condition) by using information related to the portions output from the deterioration diagnosis device 100.

The user can grasp the portions requiring repair referring to the display as illustrated in FIG. 8.

As described above, the deterioration diagnosis device 100 narrows down portions to be diagnosed by using a deterioration degree, and further narrows down portions to be diagnosed on the basis of a predetermined condition (e.g., high deterioration speed).

The selection of the portions using the deterioration diagnosis device 100 as described above will be further described with reference to the drawings.

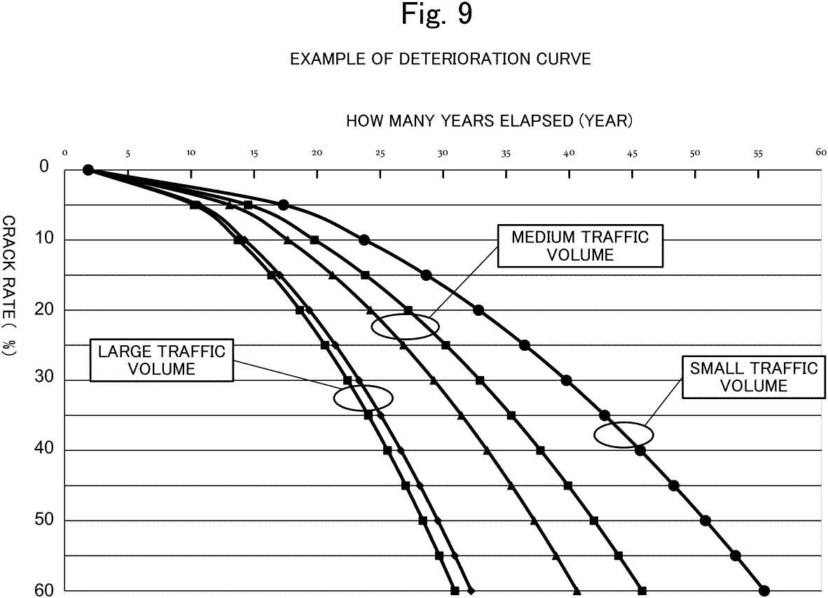

FIG. 9 is a diagram illustrating an example of a deterioration curve. FIG. 9 is an example of a case where quadratic curve regression is applied to a crack rate. In FIG. 9, a slope of the curve corresponds to a deterioration speed.

The deterioration curve changes depending on an environment of a portion to be diagnosed or the like. In FIG. 9, deterioration curves corresponding to portions that are different in traffic volume as an example of an environment are displayed. As illustrated in FIG. 9, a crack rate increases in a shorter time period in a portion with a large traffic volume than a portion with a small traffic volume.

As an example, the description will be given by using how many years elapsed when a crack rate became 20% to 30% in FIG. 9. In a case where the traffic volume is large, a crack rate becomes 20% to 30% in about three to four years. On the other hand, in a case where the traffic volume is small, a crack rate becomes 20% to 30% in about seven to eight years.

As described above, a portion with a large traffic volume deteriorates at a higher speed than a portion with a small traffic volume. Accordingly, a portion with a large traffic volume requires repair in a shorter period than a portion with a small traffic volume, even though they have the same deterioration degree. Therefore, even at the same deterioration degree, portions are different in priority of repair. The priority of repair can be determined by using a deterioration speed.

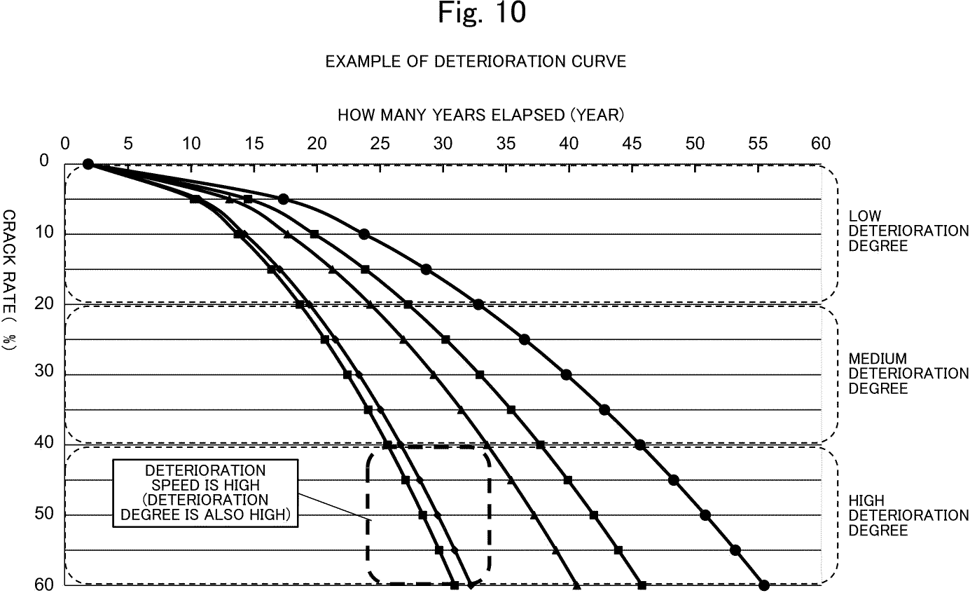

FIG. 10 is a diagram for explaining a selection of the deterioration diagnosis device 100.

The selection of portions of which deterioration degrees are high as illustrated in FIG. 6 is to select portions included in a region having a high deterioration degree in FIG. 10. However, as illustrated in FIG. 10, portions of which deterioration degrees are high include portions where the progress of deterioration is fast and portions where the progress of deterioration is relatively slow. Then, it is preferable to prioritize a portion where the progress of deterioration is fast as a repair target.

As illustrated in FIG. 10, the deterioration diagnosis device 100 can select a portion that is appropriate as a repair target (a portion of which deterioration degree is high and deterioration speed is high) by using a deterioration degree condition and a deterioration speed condition.

The deterioration diagnosis device 100 may output information other than information related to the selected portion. For example, the deterioration diagnosis device 100 may output information related to a deterioration speed corresponding to a portion designated by a user.

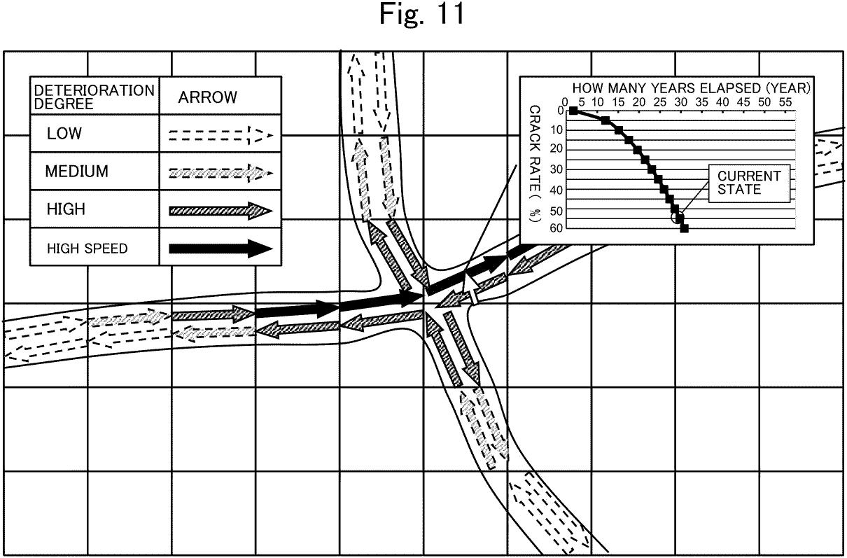

FIG. 11 is a diagram for explaining information related to a deterioration speed output by the deterioration diagnosis device 100. In FIG. 11, a deterioration curve generated based on a history of deterioration degree is displayed as the information related to the deterioration speed.

An example of a specific operation corresponding to the display illustrated in FIG. 11 is as follows.

The display device 300 and the input device 310 are formed as a computer device including a liquid crystal display, a keyboard, and a mouse.

First, a user selects a portion for which information related to a deterioration speed is to be displayed, by using the display device 300 and the input device 310. For example, as illustrated in FIG. 11, the user places a cursor on a portion for which the user desires to see information, and presses (clicks) a mouse button.

The input device 310 transmits information indicating the portion (e.g., position information of the portion) to the deterioration diagnosis device 100.

The deterioration diagnosis device 100 determines the portion by using the received information indicating the portion, and transmits information related to the determined portion (e.g., a history of deterioration degree) to the display device 300.

The display device 300 displays the received information (e.g., the history of deterioration degree) and/or information (e.g., a deterioration curve) calculated using the received information (e.g., the history of deterioration degree).

The deterioration diagnosis device 100 may output other information in addition to the information related to the deterioration speed. For example, the deterioration diagnosis device 100 may output a current deterioration degree of a designated portion in addition to the information related to the deterioration speed.

In FIG. 11, a current deterioration degree of a designated portion is displayed in addition to the information (deterioration curve) related to the deterioration speed.

The user can grasp how much time is available for repair by using the displayed current deterioration degree and the displayed deterioration curve (or history).

### Description of Effects

Next, effects of the deterioration diagnosis device 100 according to the first example embodiment will be described.

The deterioration diagnosis device 100 according to the first example embodiment can obtain an effect in that after narrowing down portions to be subjected to deterioration diagnosis by using a deterioration diagnosis result, portions to be subjected to deterioration diagnosis are further narrowed down.

The reason is as follows.

The deterioration diagnosis device 100 includes a deterioration information storage unit 130, a deterioration speed calculation unit 140, a portion selection unit 150, and an output unit 160. The deterioration information storage unit 130 stores a history of deterioration degree for a portion to be diagnosed in a structure. The deterioration speed calculation unit 140 calculates a deterioration speed of the portion on the basis of the history. The portion selection unit 150 selects a portion that satisfies a condition related to the deterioration degree and a condition related to the deterioration speed. The output unit 160 outputs information related to the selected portion.

The deterioration diagnosis device 100 calculates a deterioration speed by using the stored history of deterioration degree. Then, the deterioration diagnosis device 100 outputs information related to a portion in which the deterioration degree and the deterioration speed satisfy predetermined conditions.

A user of the deterioration diagnosis device 100 can select a portion to be diagnosed by using the deterioration speed after narrowing down portions to be diagnosed using a deterioration degree.

As a result, the user can grasp a more appropriate portion as a target of repair or the like.

The deterioration diagnosis device 100 further includes an image acquisition unit 110 and a deterioration degree calculation unit 120. The image acquisition unit 110 acquires an image including a portion to be diagnosed. The deterioration degree calculation unit 120 calculates a deterioration degree corresponding to the portion by using the image, and stores the calculated deterioration degree as a history in the deterioration information storage unit 130.

By using such a configuration, the deterioration diagnosis device 100 can store the history of deterioration degree, which is used to calculate a deterioration speed, by using the image including the portion to be diagnosed.

Furthermore, the deterioration diagnosis device 100 has an effect in that a portion to be diagnosed is more accurately selected as compared with that selected using a theoretical curve.

The reason is as follows.

In general diagnosis of deterioration with respect to a road surface, a theoretical curve (e.g., a quadratic curve) corresponding to a classification of the road surface or the like is used to indicate a deterioration speed. However, portions that are diagnosis targets on the road surface are different from each other in environments related to deterioration such as weather and traffic volume. Therefore, the actual progress of deterioration in each of the portions may deviate from the general theory.

However, the deterioration diagnosis device 100 uses a deterioration degree calculated using an image including a portion that is a diagnosis target and a deterioration speed calculated on the basis of a history of the calculated deterioration degree. In this way, the deterioration diagnosis device 100 uses a deterioration degree and a deterioration speed calculated on the basis of an actual deterioration state of a portion that is a diagnosis target. Therefore, the deterioration diagnosis device 100 can select a more appropriate portion by using a deterioration degree and a deterioration speed than that selected using a theoretical curve corresponding to the classification of the road surface. Therefore, a user of the deterioration diagnosis device 100 can select a portion to be repaired more appropriately.

The deterioration diagnosis system 10 includes a deterioration diagnosis device 100, a display device 300, and an input device 310. The input device 310 transmits selection conditions (a condition related to a deterioration degree and a condition related to a deterioration speed) to the deterioration diagnosis device 100. The deterioration diagnosis device 100 outputs information related to a portion satisfying the selection conditions on the basis of the above-described operation. The display device 300 displays the portion satisfying the selection conditions (the condition related to the deterioration degree and the condition related to the deterioration speed) by using the information related to the portion output from the deterioration diagnosis device 100.

On the basis of such a configuration, the deterioration diagnosis system 10 can provide a user with a portion to which portions are further narrowed down using a predetermined condition (a condition related to a deterioration speed) after narrowing down portions using deterioration degrees.

The deterioration diagnosis system 10 further includes an imaging device 200. The imaging device 200 captures an image including a portion to be diagnosed in a structure, and transmits the captured image to the deterioration diagnosis device 100. On the basis of such a configuration, the deterioration diagnosis system 10 can diagnose deterioration, by using an image captured by the imaging device 200, with respect to a portion of a structure included in the image.

In the present example embodiment, it has been described as an example that the deterioration degree calculation unit 120 calculates a deterioration degree by using an image acquired from the imaging device 200. However, the deterioration degree calculation unit 120 may calculate a deterioration degree by using information acquired from an acceleration sensor that is not illustrated, instead of the imaging device 200. For example, the deterioration degree calculation unit 120 may calculate an IRI as a deterioration degree according to a change in acceleration acquired from the acceleration sensor.

Alternatively, the deterioration degree calculation unit 120 may calculate a deterioration degree by using both the image acquired from the imaging device 200 and the information acquired from the acceleration sensor.

### Hardware Configuration

Next, a hardware configuration of the deterioration diagnosis device 100 will be described.

Each component of the deterioration diagnosis device 100 may be configured by a hardware circuit.

Alternatively, each component of the deterioration diagnosis device 100 may be configured using a plurality of devices connected to each other via a network.

Alternatively, a plurality of components of the deterioration diagnosis device 100 may be configured by one piece of hardware.

Alternatively, the deterioration diagnosis device 100 may be achieved as a computer device including a central processing unit (CPU), a read only memory (ROM), and a random access memory (RAM). The deterioration diagnosis device 100 may be achieved as a computer device including a network interface circuit (NIC) in addition to the above-described components. The deterioration diagnosis device 100 may be achieved as a computer device further including a graphics processing unit (GPU) in order to speed up deterioration diagnosis processing.

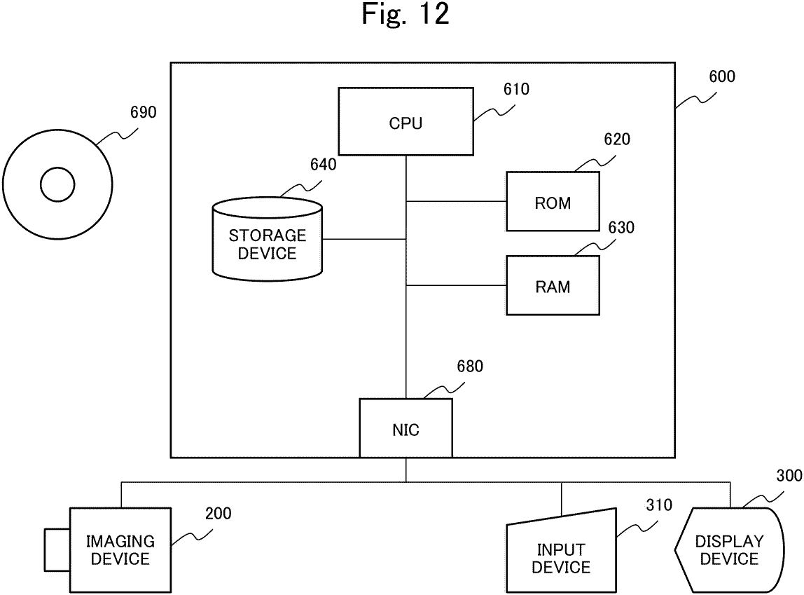

FIG. 12 is a block diagram illustrating a configuration of an information processing device 600 as an example of a hardware configuration of the deterioration diagnosis device 100.

The information processing device 600 includes a CPU 610, a ROM 620, a RAM 630, a storage device 640, and an NIC 680, constituting a computer device.

The CPU 610 reads a program from the ROM 620 and/or the storage device 640. Then, the CPU 610 controls the RAM 630, the storage device 640, and the NIC 680 on the basis of the read program. Then, the computer device including the CPU 610 controls the configurations thereof to execute functions as the image acquisition unit 110, the deterioration degree calculation unit 120, the deterioration information storage unit 130, the deterioration speed calculation unit 140, the portion selection unit 150, and the output unit 160 illustrated in FIG. 1.

When executing each function, the CPU 610 may use the RAM 630 or the storage device 640 as a temporary storage medium of the program.

In addition, the CPU 610 may read a program included in a storage medium 690, which stores the program in such a manner as to be readable by the computer device, by using a storage medium reading device that is not illustrated. Alternatively, the CPU 610 may receive a program from an external device that is not illustrated via the NIC 680, store the program in the RAM 630 or the storage device 640, and operate on the basis of the stored program.

The ROM 620 stores programs to be executed by the CPU 610 and fixed data. The ROM 620 is, for example, a programmable ROM (P-ROM) or a flash ROM.

The RAM 630 temporarily stores programs to be executed by the CPU 610 and data. The RAM 630 is, for example, a dynamic-RAM (D-RAM).

The storage device 640 stores data and programs to be stored by the information processing device 600 for a long period of time. The storage device 640 operates as the deterioration information storage unit 130. Also, the storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory storage media. On the other hand, the RAM 630 is a transitory storage medium. The CPU 610 can operate on the basis of a program stored in the ROM 620, the storage device 640, or the RAM 630. That is, the CPU 610 can operate using a non-transitory storage medium or a transitory storage medium.

The NIC 680 mediates transmission and reception of data between the information processing device 600 and the imaging device 200, between the information processing device 600 and the display device 300, and between the information processing device 600 and the input device 310. The NIC 680 is, for example, a local area network (LAN) card. Furthermore, the NIC 680 is not limited to a wired circuit, and may be a wireless circuit.

The information processing device 600 configured as described above can obtain effects similar to those of the deterioration diagnosis device 100.

This is because the CPU 610 of the information processing device 600 is capable of executing functions similar to those of the deterioration diagnosis device 100 on the basis of the program.

### Second Example Embodiment

As a second example embodiment, an outline of the deterioration diagnosis device 100 and the deterioration diagnosis system 10 according to the first example embodiment will be described.

### Description of Configuration

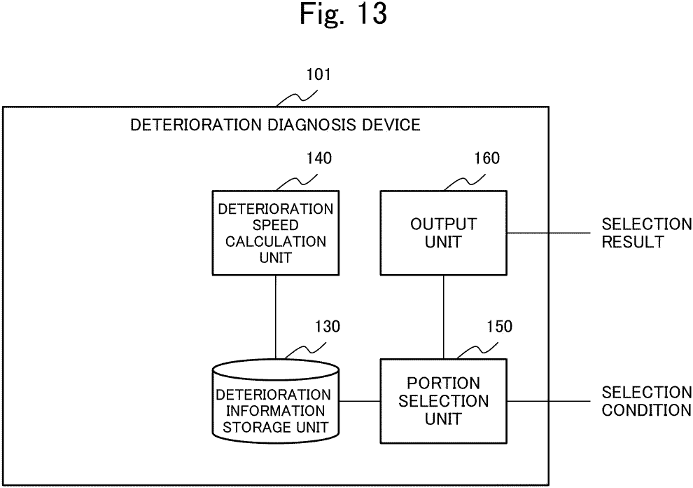

FIG. 13 is a block diagram illustrating an example of a configuration of a deterioration diagnosis device 101 according to the second example embodiment which is an outline of the deterioration diagnosis device 100 according to the first example embodiment.

The deterioration diagnosis device 101 includes a deterioration information storage unit 130, a deterioration speed calculation unit 140, a portion selection unit 150, and an output unit 160. The deterioration information storage unit 130 stores a history of deterioration degree for a portion to be diagnosed in a structure. The deterioration speed calculation unit 140 calculates a deterioration speed of the portion on the basis of the history. The portion selection unit 150 selects a portion that satisfies a condition related to the deterioration degree and a condition related to the deterioration speed. The output unit 160 outputs information related to the selected portion.

The deterioration diagnosis device 101 may be achieved using the computer device illustrated in FIG. 12.

### Description of Operation

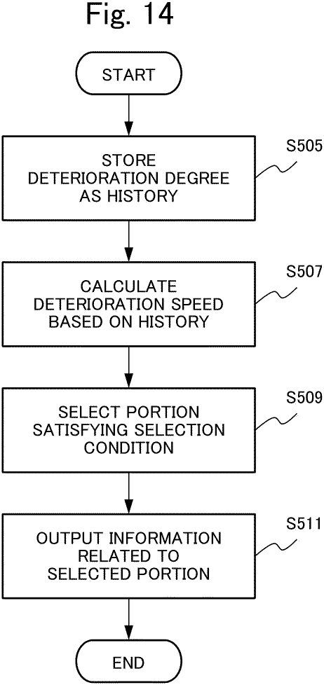

FIG. 14 is a flowchart illustrating an example of an operation of the deterioration diagnosis device 101 according to the second example embodiment.

The deterioration information storage unit 130 stores the deterioration degree as a history (step S505).

The deterioration speed calculation unit 140 calculates a deterioration speed on the basis of the history (step S507).

The portion selection unit 150 receives selection conditions (a condition related to the deterioration degree and a condition related to the deterioration speed). Then, the portion selection unit 150 selects a portion satisfying the selection conditions (step S509).

The output unit 160 outputs information related to the selected portion (step S511).

Then, the deterioration diagnosis device 101 ends the operation.

As described above, similarly to the deterioration diagnosis device 100, the deterioration diagnosis device 101 calculates a deterioration speed by using the stored history of deterioration degree. Then, the deterioration diagnosis device 101 outputs information related to a portion in which the deterioration degree and the deterioration speed satisfy predetermined conditions.

### Description of Effects

Similarly to the deterioration diagnosis device according to the first example embodiment, the deterioration diagnosis device 101 can obtain an effect in that after narrowing down portions to be subjected to deterioration diagnosis by using a deterioration diagnosis result, portions to be subjected to deterioration diagnosis are further narrowed down.

This is because each component of the deterioration diagnosis device 101 operates similarly to the corresponding component in the deterioration diagnosis device 100.

The deterioration diagnosis device 101 in FIG. 13 has a minimum configuration of the deterioration diagnosis device 100 in the first example embodiment.

### Description of System

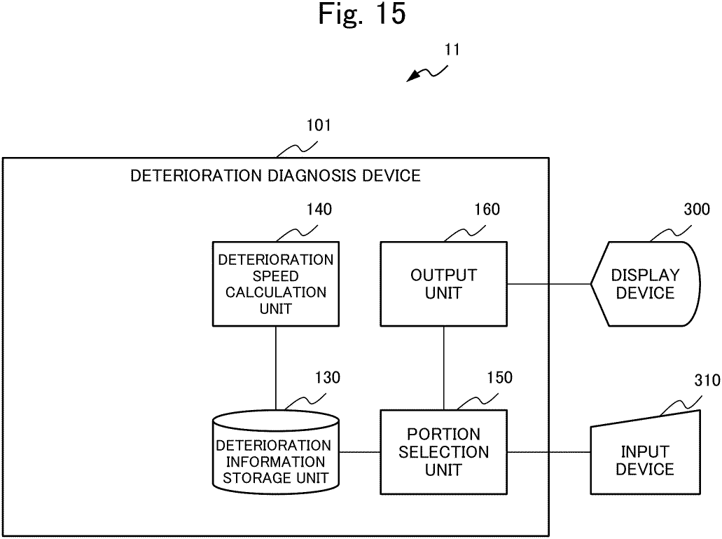

FIG. 15 is a block diagram illustrating an example of a configuration of a deterioration diagnosis system 11 including the deterioration diagnosis device 101 according to the second example embodiment.

The deterioration diagnosis system 11 includes a deterioration diagnosis device 101, a display device 300, and an input device 310. The input device 310 transmits selection conditions (a condition related to a deterioration degree and a condition related to a deterioration speed) to the deterioration diagnosis device 101. The deterioration diagnosis device 101 outputs information related to a portion satisfying the selection conditions on the basis of the above-described operation. The display device 300 displays the portion satisfying the selection conditions (the condition related to the deterioration degree and the condition related to the deterioration speed) by using the information related to the portion output from the deterioration diagnosis device 101.

On the basis of such a configuration, the deterioration diagnosis system 11 can provide a user with a portion to which deterioration diagnosis targets are further narrowed down on the basis of a predetermined condition after narrowing down deterioration diagnosis targets using a diagnosis result.

The deterioration diagnosis system 11 in FIG. 14 has a minimum configuration of the deterioration diagnosis system 10 in the first example embodiment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### Industrial Applicability

The present invention is applicable to a transport system using information technology (IT) such as an intelligent transport system (ITS).

This application is based upon and claims the benefit of priority from Japanese patent application No. 2020-062914, filed on Mar. 31, 2020, the disclosure of which is incorporated herein in its entirety by reference.

### REFERENCE SIGNS LIST

10 Deterioration diagnosis system
11 Deterioration diagnosis system
100 Deterioration diagnosis device
101 Deterioration diagnosis device
110 Image acquisition unit
120 Deterioration degree calculation unit
130 Deterioration information storage unit
140 Deterioration speed calculation unit
150 Section selection unit
160 Output unit
200 Imaging device
300 Display device
310 Input device
410 Information processing device
420 Network
430 Communication path
440 Vehicle
450 Facility
600 Information processing device
610 CPU
620 ROM
630 RAM
640 Storage device
660 Input device
670 Display device
680 NIC
690 Storage medium

What is claimed is:

1. A deterioration diagnosis device comprising:
a memory; and
at least one processor coupled to the memory,
the processor performing operations, the operations comprising:
storing a history of a deterioration degree of a portion to be diagnosed in a structure;
calculating a deterioration speed of the portion based on the history;
selecting the portion satisfying a condition related to the deterioration degree and a condition related to the deterioration speed; and
outputting information related to the selected portion.

2. The deterioration diagnosis device according to claim 1, wherein the operations further comprise:
outputting information related to a position of the portion as the information related to the selected portion.

3. The deterioration diagnosis device according to claim 1, wherein the operations further comprise:
acquire acquiringan image including the portion to be diagnosed; and
calculating the deterioration degree corresponding to the portion by using the image, and storing the calculated deterioration degree as the history.

4-5. (canceled)

6. A deterioration diagnosis method comprising:
storing a history of a deterioration degree of a portion to be diagnosed in a structure;
calculating a deterioration speed of the portion based on the history;
selecting the portion satisfying a condition related to the deterioration degree and a condition related to the deterioration speed; and
outputting information related to the selected portion.

7. A non-transitory computer-readable recording medium embodying a program, the program causing a computer to perform a method, the method comprising:
storing a history of a deterioration degree of a portion to be diagnosed in a structure;
calculating a deterioration speed of the portion based on the history;
selecting the portion satisfying a condition related to the deterioration degree and a condition related to the deterioration speed; and
outputting information related to the selected portion.
